(19) United States
(12) Patent Application Publication
(10) Pub. No.: US 2007/0169258 A1
(43) Pub. Date: Jul. 26, 2007

(54) Foldable sauna

(76) Inventor: Gunther Hoge, Überlingen (DE)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/596,144

(22) PCT Filed: Sep. 22, 2004
(86) PCT No.: PCT/EP04/10585

§ 371 Date: Jun. 1, 2006

(30) Foreign Application Priority Data
Dec. 3, 2003 (CH) 2061/03

(51) Int. Cl. A61H 33/06

(52) U.S. Cl. 4/527

(57) ABSTRACT

The invention relates to a foldable sauna (1) comprising a sectional floor surface, two lateral walls each of which is provided with two rigid lateral wall elements (3a, 3b, 3c) collapsibly connected to each other, a rear wall comprising at least two flexible sequences each of which consists of at least two solid rear wall elements, wherein said sequence elements are superposed in the unfolded state thereof: The inventive sauna also comprises a flexible covering (13) which, when the sauna is unfolded, extends between said lateral walls and covers at least partially the internal space thereof. The rear wall and possibly the floor space consist of at least two solid floors (2a, 2b, 2c) or rear wall (4a, 4b, 4c, 4d; 5a, 5b, 5c, 5d) elements, respectively which are collapsibly connected to each other. When folded, said sauna is generally embodied in the form a suitcase. The foldable floor, rear wall and lateral walls of the sauna make it possible to easily carry sad sauna in the folded state thereof and to easily mount it y one person.

The invention relates to a foldable sauna according to the precharacterizing clause of Claim 1.

In many applications there is a need for making it possible to utilise the advantageous effects of a sauna even without the fixed installation of a conventional sauna. Home saunas which are constructed under the conditions of a normal living space and are generally heated by heating lamps in the far infrared range are used for this purpose. The sauna is designed for use by only one person and is capable of being dismantled. In addition to conventional tent-like concepts having an internal rod skeleton, there are also collapsible variants which generally have a rigid component and afford handling which is simplified compared with this tent type.

Thus, for example, JP 11028240 discloses a folding sauna which comprises a rear wall and lateral folding walls and a front wall. When erecting the folding sauna, the rear wall is held vertically and at the same time the front wall is moved away from the rear wall. The two lateral folding walls with the vertical folding lines and the wall elements arranged in between are unfolded which requires a movement of the folding walls over the floor. The rear wall has the width and the height of the erected folding sauna and is therefore a comparatively bulky part which is difficult to carry and to store. At least two persons are required for the erection, one person holding the rear wall and the other person pulling the front wall away from the rear wall.

The publications JP 11253521, JP 7213578, JP 10043268 and U.S. Pat. No. 6,055,684 describe sauna cabins having a box-like rear part. One folding wall each is adjacent to the two lateral wall surfaces of the box-like rear part. These folding walls comprise wall elements which are connected to one another via vertical folding lines. The box-like rear part has the width and the height of the erected folding sauna and a depth of its lateral wall surfaces. This results in a bulky part which is difficult to carry and to store. During erection, there is the danger that the box-like rear part placed on the lower lateral surface does not stand sufficiently securely before the unfolding of the folding wall and may tilt when accidentally touched, so that once again two persons are required for safe handling. The folding sauna according to JP 7213578 comprises a frame having a floor surface, the frame being pivotably connected to the box-like rear part. After the unfolding of the folding walls, the floor surface is pivoted out of the vertical position in the rear part into a horizontal position on the floor. The large rear part with the folding walls, the floor surface pivotably mounted thereon and a seat surface arranged between these parts can only be carried by two persons in the collapsed state, owing to the large external dimensions.

The solutions of the prior art therefore require at least difficult handling during erection, in which two persons are required for safe unfolding. Moreover, the horizontal unfolding movement results in scraping of the lateral parts against the floor.

If various components are integrated in the rear part, such as, for example, power supply and electronics these will be difficult to erect and to transfer.

Because of the horizontal unfolding, the floor of the sauna is formed from flexible or folding material or parts. This results in many flexing, deformation, or hinge zones which have an inherent susceptibility with regard to tightness.

Moreover, the base surface of the sauna is clearly recognisable only after unfolding is complete, so that positioning before erection of the sauna may involve incorrect estimations of the space required.

An object of the invention is to provide a sauna which permits easier handling compared with the prior art. In particular, positioning in a room should be possible, after which no change at all of orientation, standing area used or position of the sauna is required.

A further object is the integration of components or peripheral equipment into the sauna without resulting in handling disadvantages thereby, for example through unfavourable weight distributions.

A further object is the improved sealing of the floor region and of the base surface of the sauna, for example with respect to condensation.

These objects are achieved, according to the invention, by realising the features of claim 1 and the features of the subclaims, or the solutions are further developed.

The present invention relates to a folding sauna in which the unfolding is effected substantially vertically from a floor panel, the folding sauna being easily transportable in the collapsed state, for example as a result of being designed in the form of a case.

The folding sauna is formed in such a way that it can be brought into a state collapsed to form a case. To enable such a case to be conveniently carried, for example by a handle arranged on the top it should have a height which is less than 70 cm, but preferably less than 60 cm, particularly less than 55 cm. However, because the floor surface of a folding sauna now has a length and a width of at least 70 cm preferably of substantially 80 cm it can be formed to be foldable for permitting a desired case form. Because the rear wall is once again larger than the floor surface, this rear wall too, should be formed so as to be foldable. With foldable floor and foldable rear wall and foldable lateral walls, it is possible to ensure, according to the invention, that the folding sauna is easy to carry and to store in the collapsed state.

By a design according to a special embodiment, it is possible to ensure that the folding sauna can be erected by one person without difficulties. This is possible, for example, if the folding lines run substantially horizontally between the wall elements of the lateral walls in the folded state of the folded sauna. As a result of such a path of the flexing or folding zones, the lateral walls are flexibly or deformably connected to the floor surface via folding lines. During erection they are not folded away from the rear wall, as in the case of the solutions according to the prior art, but can be unfolded safely and conveniently by one person from the floor surface resting in a stable manner and in an accurate position on the floor. Further advantages of unfolding starting from a floor surface is that the floor surface can be formed from one piece or with not more than one folding line in a manner advantageous for the collection of water so that no water reaches the floor of the building during the use of the folding sauna.

Embodiments in which the floor surface and the rear wall each comprise at least three firm elements which are connected to one another via folding connections can be designed so that two firm floor elements form outer surfaces, namely two large lateral surfaces, in the state collapsed to form a case. After the unfolding of these outer surfaces and of the two large lateral surfaces with the wall elements of the lateral wall and of the rear wall which are arranged thereon, for example, the elements of the rear wall can be folded away so that the elements of the lateral walls are exposed. After the unfolding of a lateral wall, the adjacent element of the rear wall can be brought from the folded away position into a corner connection with the lateral wall so that a lateral wall and an element of the rear wall form a stable corner region. The other lateral wall with the adjacent element of the rear wall is then erected to form a second stable corner element. The rear wall can be closed with a middle element of the rear wall. The firm elements which are connected to one another during erection, as, for example in the case of the corner connections, can be fixed by means of generally known connections, such as, for example click or snap-in systems. It is clear that connections by means of clasps or hook and loop fasteners are also possible.

When the folding sauna is in the unfolded state, a flexible cover which at least partly covers the interior of the folding sauna extends between the lateral walls. In order for the flexible cover to achieve an insulating effect, it may be formed in a plurality of layers, for example having two outer layers and an insulation layer arranged in between. This cover can, however, also be formed from a plurality or multiplicity of rigid components, for example in the form of a blind or of an articulated door. In order to permit access to the interior an entry device which is easy to open and to close is provided in the cover or the connection thereof to a lateral wall. The entry device is provided, for example by a zip which is arranged in the flexible cover and extends between the lateral walls from a region close to the floor towards the rear wall. In the vicinity of the rear wall, in particular at the upper end of the entry device a neck opening is provided in the flexible cover so that only the head of a person projects above the flexible cover after entry into the folding sauna and closing of the entry device. To enable this person also to operate controls and, if appropriate, to consume beverages for example at least one closable arm passage is provided in the flexible cover. To enable the folding sauna to be preheated before the entry of a person a cover for the neck opening is, if appropriate, provided. This opening cover can be arranged as a flap on the flexible cover or as a pivotable fixed element on the rear wall.

The flexible cover can be firmly connected to the upper edges of the lateral walls and, after collapsing of the lateral walls, can be placed on these and then covered by the elements of the rear wall. To ensure that the erection and dismantling of the folding sauna wall is not complicated by the flexible cover, it is expedient if said cover is not firmly connected to the lateral walls. The flexible cover can be separately dismantled or rolled up and then inserted into a receptacle of the folding sauna collapsed to form a case.

The connection between the flexible cover and the walls of the folding sauna should be capable of being achieved in a simple manner and should ensure the necessary tightness. For this purpose the lateral borders of the flexible cover cooperate, at least in the unrolled state, with retaining devices of the two lateral walls. The retaining device may comprise zips and hook-and-loop, snap-in and plug connections. If appropriate, however, the retaining devices are in the form of guides so that the flexible cover can be drawn over the region to be covered with guidance at both lateral edges.

Such guides are particularly advantageous when the flexible cover is wound around a rod-like element, preferably with a spring-like restoring device. The rod-like element can be inserted into one holder each on the two lateral walls on erection of the folding sauna; if the floor of the folding sauna is formed in one part and without folding lines this element can be integrated on the front thereof which borders the entry opening on the floor side. After introduction of the lateral edges of the flexible cover into the guides the cover is drawn towards the rear wall and brought into tight contact therewith. On dismantling, the flexible cover can be separated from the rear wall and wound on to the rod-like element and removed from the holders. If the flexible cover is designed to be rolled up by means of a spring a person can conveniently sit in the sauna and grip the cover present on the floor and pull it out in the direction of the head to provide a covering. Such guidance of the cover is not possible, for example, in the solutions of the prior art with unfolding from a rear part since, in such a design, the cover would have to be drawn over the head.

Holders for beverage containers and for operating and/or display devices can be arranged on the firm wall elements of the lateral walls. As a result of the connections between the firm wall elements of all walls, all wall elements are so stable that it is even possible to place glasses in a holder fixed to a wall element without there being any danger of tilting or falling out. The material of the firm wall and floor elements comprises, for example, carbon. However, it is also possible to use rigid plastic or wood for producing the firm elements. If appropriate, heating elements and operating and/or display devices are arranged directly on the firm wall elements or integrated therein. The operating and/or display devices are connected to a control device which in turn is connected to the heating elements, a supply connection and, if appropriate, at least one sensor, in particular a temperature sensor. The connecting cables are held, for example, in or on the firm elements. For the electrical supply, for example a connection to an automatic cable pull-in is provided, the cable pull-in being arranged on a firm element. The control device, and, if appropriate further components such as, for example, the cable pull-in, can be arranged, for example in or on a floor element so that, if appropriate, they are also accessible for checks or repairs when the folding sauna is in the collapsed state. The housing of the supply and switching devices required for the folding sauna in a floor element has the advantages of good positionability and integrated, protected, in particular sealable, housing of the components.

In designing the appearance of the erected folding sauna this technical development according to the invention gives rise to many possibilities. Thus, for example, the impression of a racing car cockpit can be achieved. If appropriate, the holder for beverages and/or the operating device may be in the form of an external mirror. The racing character can be reinforced by a colour combination customary in the case of racing cars, for example red/black. In addition, the person using the sauna can be recommended to wear a helmet, for example, a holder for the helmet being provided on the wall element. This helmet may also have the functionality of a cover which can be used for preheating. If appropriate, a tank cover which can be opened in particular by means of a knob mechanism is provided on a wall element.

For easy transportability and for storing of the folding sauna, the compactness thereof, which is achieved by the design as a collapsible sauna, is of particular importance. This is realised according to the invention, for example, if the two lateral walls comprising a plurality of lateral wall elements, if appropriate comprising large and small lateral wall elements, lie in the components of a multipart floor element in the collapsed state. Prior to erection, the rear wall elements rest on the still collapsed lateral wall elements. Pivot connections permit the erection of the elements. The folding permits simple unfolding without a change of location.

A possible embodiment of the foldable sauna according to the invention is shown schematically below with reference to drawings and is described in more detail purely by way of example. Specifically,

FIG. 1 shows a perspective diagram of a folding sauna according to the invention;

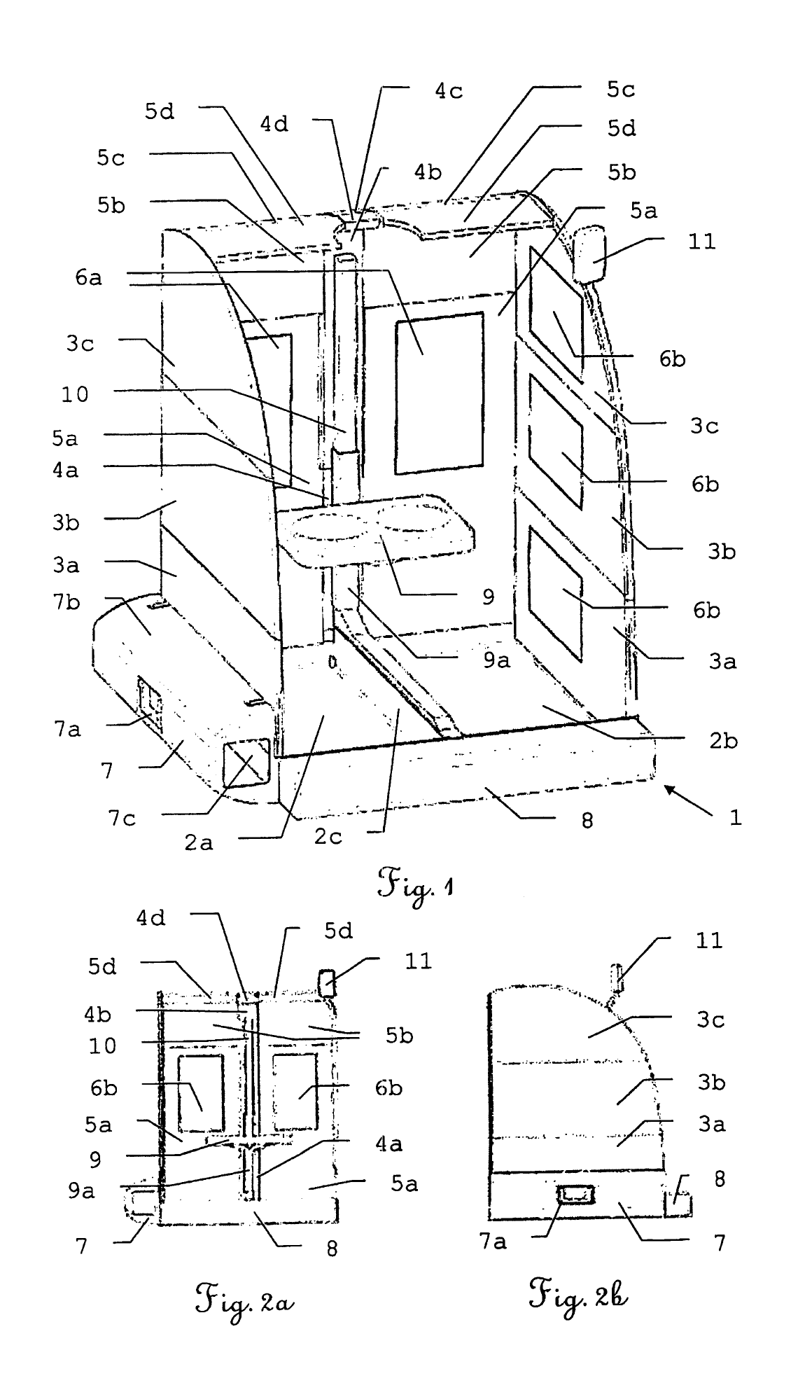

FIG. 2a-b show diagrams of the folding sauna in a front and side view;

FIG. 3 shows a perspective diagram of the folding sauna in a rear view;

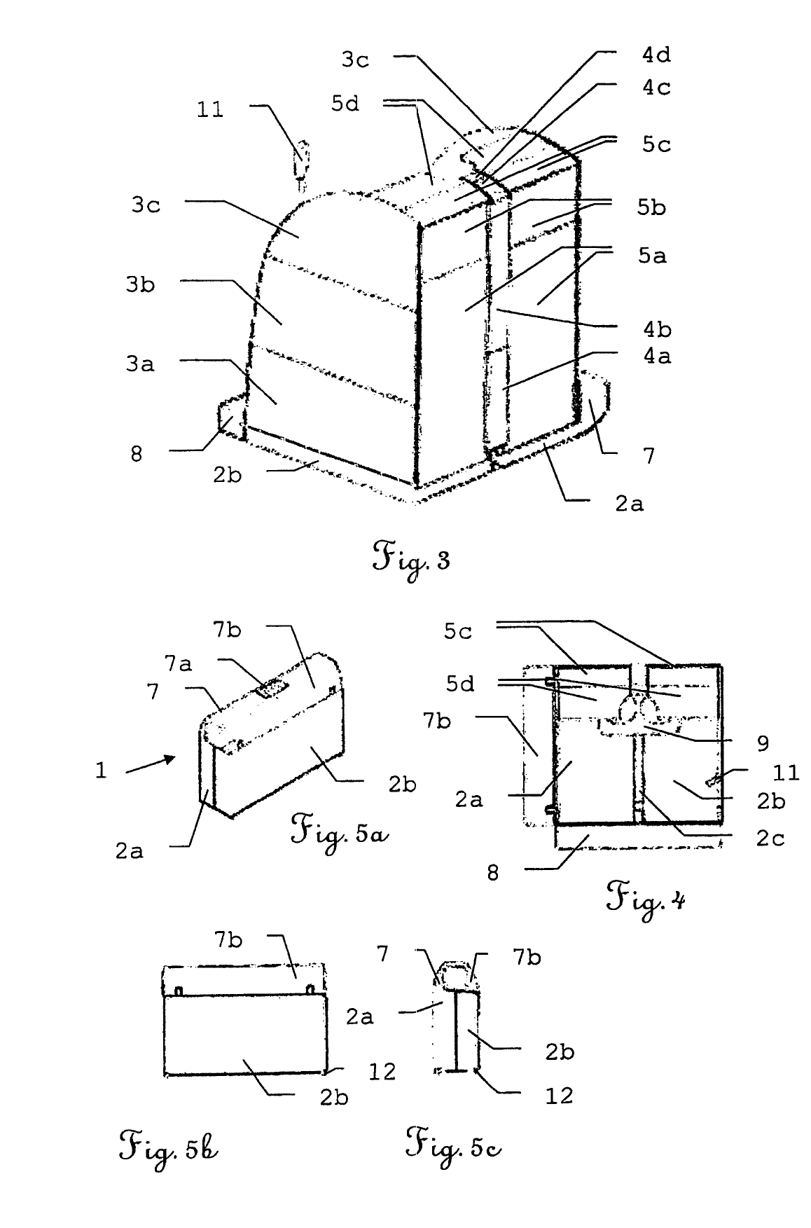

FIG. 4 shows a diagram of the folding sauna in plan view;

FIG. 5a-c show diagrams of the folding sauna collapsed into the form of a case;

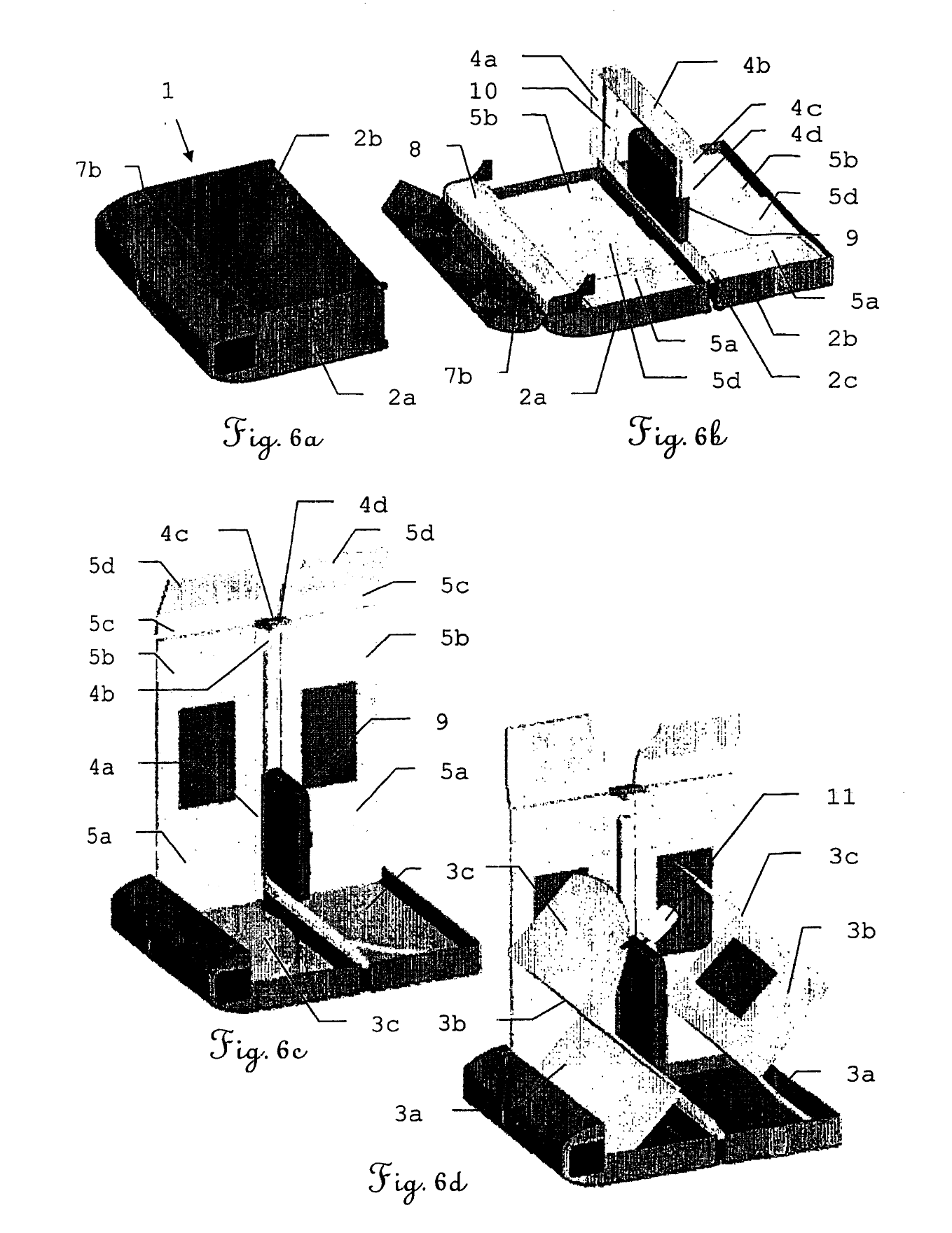

FIG. 6a-f show a consecutive representation of the unfolding process for erecting a first working example of the folding sauna according to the invention;

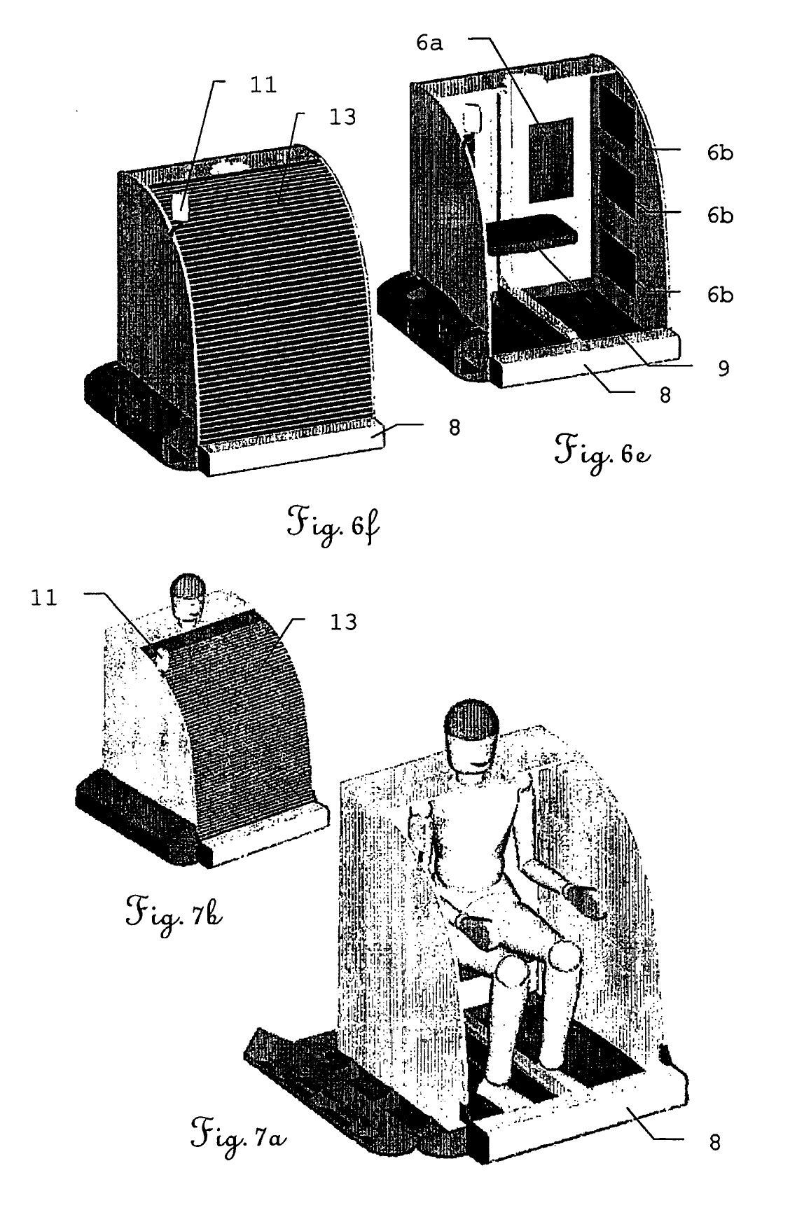

FIG. 7a-b show diagrams of the use of the first working example of the folding sauna in the operating state;

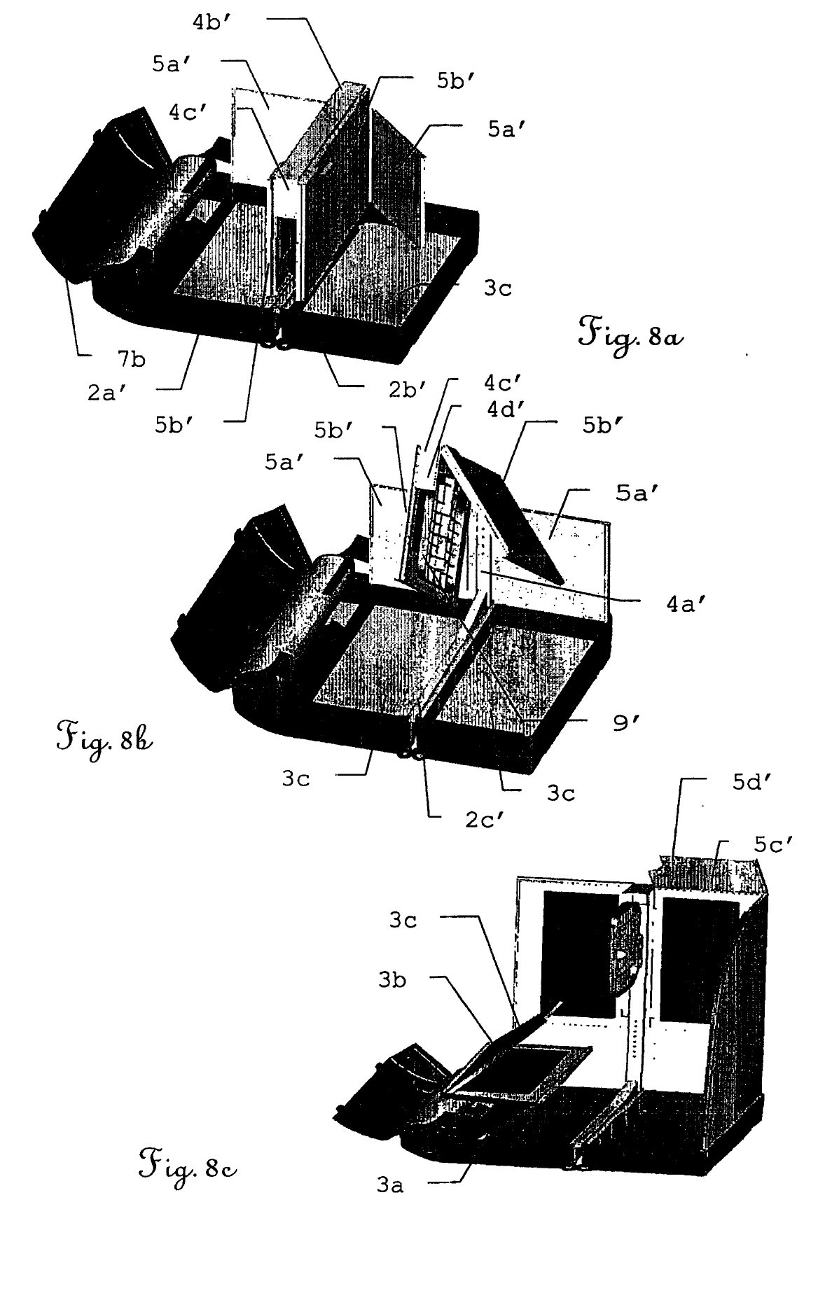

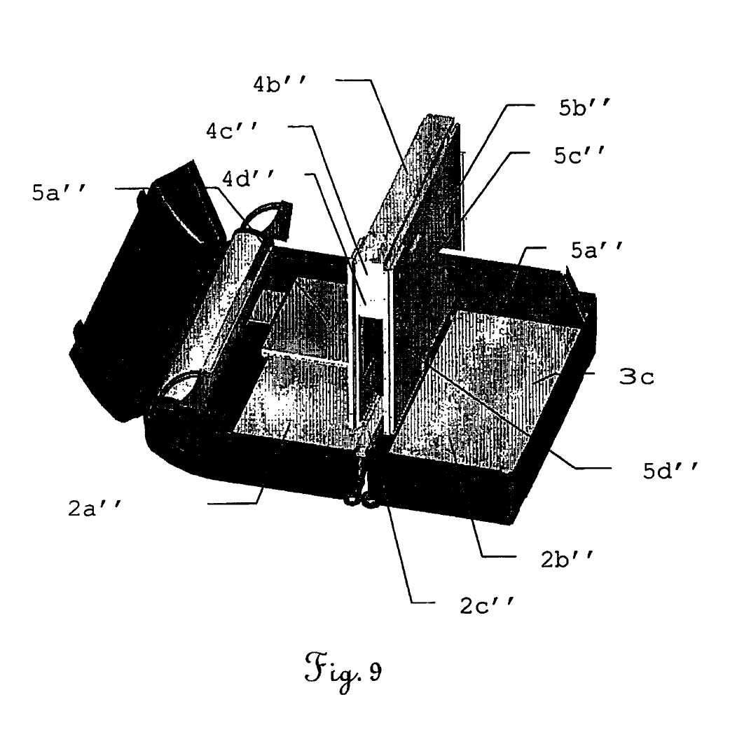

FIG. 8a-c show a consecutive representation of the unfolding process for erecting a second working example of the folding sauna according to the invention; and

FIG. 9 shows a diagram of the first step of the unfolding process for erecting a third working example of the folding sauna according to the invention.

FIG. 1 shows a perspective diagram of a folding sauna 1 according to the invention in the completely erected state before use. The following design features are in principle common to various working examples of the folding sauna according to the invention which are shown in the further figures. The floor of the folding sauna is formed by a first floor element 2a and a second floor element 2b, which are movably mounted on a narrow third floor element 2c as a connecting piece. In order to provide a water-tight floor surface, the pivot connections between the floor elements and in each case the first lateral wall elements 3a and the first rear wall elements 5a and, if appropriate, the first middle element 4a comprise tight connecting elements, for example in the form of flexible layer material, the tight connecting elements being capable in particular also of directly performing the hinge function.

The two lateral walls have first lateral wall elements 3a, second lateral wall elements 3b and third lateral wall elements 3c which in each case are connected to one another so as to be foldable. The rear wall is formed by two rear wall combinations of rear wall elements having in each case a first rear wall element 5a, a second rear wall element 5b, a third rear wall element 5c and a fourth rear wall element 5d. The two combinations are connected via a multipart middle piece to a first middle element 4a, a second middle element 4b, a third middle element 4c and a fourth middle element 4d, it being possible, if appropriate to ensure the covering of a neck opening by the fourth middle element 4d when the folding sauna is in the erected state. The elements of rear wall, middle piece and lateral walls are designed so as to be movable relative to one another, for example by pivot connections. The fixing or fastening thereof can be effected by generally known devices, such as, for example, snap-in holders. According to the invention, it is possible to use in particular extendable connecting elements, such as, for example, an elastic cable pull, which can be pulled apart for erection and can be snapped in under load after positioning of the wall elements. The unfolding is then effected by pulling apart the elements and subsequent snapping in. The terms pivotable or foldable are to be understood in this context in the sense of a displacement into a collapsed state and designate the possibility of a movement of elements relative to one another.

Infrared lamps 6a and 6b are arranged on the inside of the rear wall and of both lateral surfaces.

The folding sauna 1 is closed by a cover which can be unrolled from a box 8 as a receptacle, it being possible to store the box for transport purposes in the upper part 7. of the case which is accessible through a flap 7b. A handle 7a is mounted on the upper part 7 of the case. Alternatively or additionally, the box 8 can be pulled out of the upper part 7 of the case without a flap 7b if a suitable opening 7c is present. A user of the folding sauna 1 can sit on a seat 9 which is formed in a height-adjustable manner above a sleeve 9a and a sectional and hinged rail 10. The rail 10 is fixed to the first middle element 4a and second middle element 4b. For checking and controlling the folding sauna 1, a control and monitoring element 11 is used.

FIG. 2a-b show diagrams of the folding sauna in front and side view, whereas FIG. 3 shows a perspective diagram in rear view and FIG. 4 a plan view.

FIG. 5a-c show diagrams of the folding sauna 1 collapsed to form a case. For transport and for storage of the folding sauna 1, the latter can be collapsed in the form of a case. FIG. 5a shows this state in a view obliquely from above. The first floor element 2a and the second floor element 2b form the sides of the case while the case is closed at the top by the upper part 7 of the case with the flap 7b and the carrying handle 7a. FIG. 5b shows the case in a view onto the second floor element 2b, which forms one of the two outer surfaces of the case. The view of the end face of the case appears in FIG. 5c. For protection of the floor elements and for better positioning, the case may have knobs or buffer elements 12 which ensure exact contact with the floor and which, for example, may consist of rubber or plastic.

The unfolding and preparation for commissioning of a first working example of the folding sauna 1 according to the invention is explained in a consecutive diagram in FIG. 6a-f.

As shown in FIG. 6a, the beginning of the unfolding and erection process comprises placing the folding sauna 1 collapsed to form a case on the outside of the first floor element 2a so that the flap 7b and the outside of the second floor element 2b face upwards. From this position, the state shown in FIG. 6b is assumed by opening the case. In each case a lateral surface and a rear wall combination are present in the case halves formed by the two floor elements 2a and 2b. The seat 9 and the collapsed middle section with the rail 10 are recognisable on the third floor element 2c. The box 8 which holds the flexible cover is recognisable through the opened flab 7b in the upper part of the case. The box 8 is removed from or swivelled out of the upper part of the case and mounted on the end face of the first and second floor elements 2a and 2b so that the folding sauna can be closed by the cover.

FIG. 6c shows the erection of the rear wall, first and second rear wall elements Sa and 5b forming the actual rear wall, whereas the third and fourth rear wall elements 5c and 5d also provide covering at the top and, owing to their design, define an opening for the user's head. All rear wall elements Sa, 5b, 5c and 5d are connected to one another and foldable horizontally against one another. The rear wall elements 5a, Sb, Sc and 5d form a sequence. The middle section which provides the connection between the rear wall combinations and likewise represents a sequence is unfolded in a similar manner. In this state of unfolding, the seat 9 with its seat surface is still vertically positioned. In the first and second floor elements, the uppermost third lateral wall elements 3c of the collapsed lateral walls are recognisable.

As shown in FIG. 6d, these lateral walls are unfolded upwards so that, after the abovementioned mounting of the box 8 and rotation of the seat 9, the situation shown in FIG. 6e results. For producing the sauna effect, the interior is heated by the infrared lamps 6a and 6b arranged on the inside of the rear wall and on the inside of the lateral surfaces.

The state of the sauna during operation is shown in FIG. 6f. For this purpose, the front is closed by the flexible cover 13 present in the box 8. The operation of the sauna is monitored and controlled by the control and monitoring element 11 which can be mounted on the left or right.

FIG. 7a-b show diagrams of the use of the folding sauna in the operating state with a user. For using the sauna, a user sits on the seat and bends forwards towards the box 8, from which he pulls the cover 13 present therein upwards until it completely covers the front of the sauna. Simple and convenient handling is ensured by a springy restoring device and in particular a snap-in device, so that unrolled cover material is rolled up after unlocking the snap-in device.

For the flexible cover 13 to have an insulating effect, it can be formed in multiple layers, for example with two outer layers and an insulating layer arranged in between. In order to permit access to the interior, a zip which extends between the lateral walls from a region close to the floor towards the rear wall can be arranged in the cover 13. Depending on the design, a neck opening is provided in the flexible cover 13 in the vicinity of the rear wall, so that, after entering the folding sauna and closing the zip, only a person's head projects above the flexible cover 13, or the cover 13 closes with a straight edge so that the recess for the head must be introduced in the other components of the rear wall or of the middle section. To enable the user also to operate the control and monitoring element 11 and, if desired, to consume beverages, for example, at least one closable arm passage in the flexible cover or the lateral walls can be realised. To enable the folding sauna to be preheated before a person enters, the fourth middle element is optionally positioned to cover the neck opening.

Holders for beverage containers and for further operating and/or display devices, such as, for example, for game consoles can be mounted on the firm wall elements of lateral walls and are not shown.

FIG. 8a-c show a consecutive diagram of the unfolding process for erecting a second working example of the folding sauna according to the invention.

FIG. 8a shows the first step for erecting the rear wall. The folding sauna is opened and is placed so that first floor element 2a′ and second floor element 2b′ face upwards. The collapsed lateral surfaces are present in each case in the case halves formed by the two floor elements 2a′ and 2b′. The rear wall elements are fixed to the third floor element 2c′ by means of the middle section. The multipart middle section has a first middle element 4a′ (not visible in FIG. 8a), a second middle element 4b′, a third middle element 4c′ and optionally one or more further middle elements. In this second working example, two first rear wall elements 5a′ arranged at the bottom are pivotably connected to the first middle element 4a′, the pivot axis being vertical so that the first rear wall elements 5a′ are swivelled outwards or backwards out of the interior of the case.

A further unfolding step of the second working example is shown in FIG. 8b. The second rear wall elements 5b′ are pivotably connected to the second middle element 4b′. After the erection or unfolding of the second middle element 4b′, the second rear wall elements 5b′ are swivelled backwards or outwards so that the state shown in FIG. 8c finally results. A seat 9′ which is rotatable in the longitudinal direction of the second middle element 4b′ for collapsing is arranged on the second middle element 4b′. The third rear wall elements 5c′ and the fourth rear wall elements 5d′ are pivotably connected to one another and to the second rear wall elements 5b′ so that they can be unfolded upwards to close the folding sauna. The first lateral wall elements 3a, second lateral wall elements 3b and third lateral wall elements 3c are subsequently unfolded upwards from the two floor elements of the case.

FIG. 9 shows a diagram of the first step of the unfolding process for erection of a third working example of the folding sauna according to the invention. The first rear wall elements 5a″ are pivotably fixed to the first floor element 2a″ and the second floor element 2b″, the unfolding axes being horizontal. The second rear wall elements 5b″ are hinged to the second middle element 4b″, the third rear wall elements 5c″ and the fourth rear wall elements 5d″ being pivotably connected to one another and to the second rear wall elements 5b″. The further unfolding process resembles that in the working examples shown in the preceding Figures.

The working examples shown are only examples of possible variants of the foldable sauna according to the invention and are therefore not to be understood as being definitive and limiting. Moreover, the person skilled in the art can derive a further division of the components which is suitable for a folding sauna according to the invention, for example by forming the floor element from five or more sections, by other geometrical shapes of the lateral parts or by a different arrangement of folding lines.

1. A folding sauna comprising:
a floor surface;
two lateral walls each having at least two firm lateral wall elements (3c) each, the firm lateral wall elements being connected to one another so as to be foldable;
a flexible cover which, in an unfolded state of the folding sauna, extends between the lateral walls and at least partly covers an interior of the folding sauna; and
a rear wall having at least two sequences of at least two firm rear wall elements, wherein, in each case, the firm rear wall elements of a sequence are arranged one on top of the other in the unfolded state.

2. A folding sauna according to claim 1, wherein the floor surface has at least two firm floor elements which are connected to one another so as to be foldable.

3. A folding sauna Folding according to claim 2, wherein the firm floor elements in a collapsed state define outer surfaces of a case-like container.

4. A folding sauna according to claim 1, wherein folding lines between the firm lateral wall elements are substantially horizontal in the unfolded state of the folding sauna.

5. A folding sauna according to claim 1, wherein the folding sauna in the collapsed state has in only one direction a dimension which substantially corresponds to the length or width of the floor surface and has in the other two directions dimensions which are substantially less than the length or width of the floor surface.

6. A folding sauna according to claim 2, wherein the lateral walls and the floor surface comprise at least three firm elements, including said firm lateral wall elements and said firm floor elements, which are connected to one another via folding connections.

7. A folding sauna according to claim 1, wherein the firm rear wall elements within a sequence, are connected to one another via folding connections.

8. A folding sauna according to claim 1, wherein at least one firm rear wall element of a sequence, is connected to the floor surface via a folding connection.

9. A folding sauna according to claim 1, wherein the flexible cover can be wound around a rod-like element, which element can be inserted into a holder, and, at least in an unrolled state, the lateral borders of the flexible cover cooperate with retaining devices to provide a covering.

10. A folding sauna according to claim 9, wherein the retaining devices are in the form of guides in which the lateral borders of the flexible cover are guided when the flexible cover is rolled out and rolled in.

11. A folding sauna according to claim 1. wherein chair elements of a seat are foldably, rotatably or pivotably fixed to the firm rear wall elements or to firm floor elements.

12. A folding sauna according to claim 1, wherein a cover element for covering an opening in the flexible cover is arranged on the rear wall, which cover element can be brought into a covering position and into an uncovering position.

13. A folding sauna according to claim 1, wherein a receiving region for receiving the flexible cover is formed, which receiving region is integrated in the case-like design when the folding sauna is in a collapsed state to form a case.

14. A folding sauna according to claim 1, wherein the floor surface has at least three firm floor elements which are connected to one another so as to be foldable

15. A folding sauna according to claim 8, wherein a firm rear wall element of each sequence is connected to the floor surface via a folding connection.

16. A folding sauna according to claim 9, wherein the rod-like element includes a springy restoring device.
